(19) United States
(12) Patent Application Publication
(10) Pub. No.: US 2006/0166177 A1
(43) Pub. Date: Jul. 27, 2006

(54) Method of incorporating an active learning experience into a classroom

(76) Inventor: James H. Hageman, Mt. Pleasant, MI (US)

Correspondence Address: MCKELLAR IP LAW, PLLC, 784 SOUTH POSEYVILLE ROAD, MIDLAND, MI, 48640, US

(21) Appl. No.: 11/390,514

(22) Filed: Mar. 27, 2006

Related U.S. Application Data
(63) Continuation-in-part of application No. 10/630,171, filed on Jul. 30, 2003, now abandoned.

(51) Int. Cl. G09B 23/00

(52) U.S. Cl. 434/276

(57) ABSTRACT

What is disclosed herein relates to a method of educating students, such as high school or introductory college students, in the field of chemical sciences. More specifically, the method is a means of reducing barriers to active learning in a chemistry classroom through the use of interactive kits and instruction.

This application claims priority from U.S. Utility Patent Application Ser. No. 10/630,171 filed Jul. 30, 2003.

### BACKGROUND

The instant invention relates to educating students, such as high school or introductory college students, in the field of chemical sciences. More specifically, the instant invention is a method of reducing barriers to active learning in a chemistry classroom through the use of interactive kits and instruction.

Active learning strategies have a powerful impact on student conceptual learning in science. However, these strategies are not easily adapted by instructors who struggle to make the transition from traditional methods of instruction. With respect to chemistry, a choice tool that instructors could easily adapt in this effort involve in-class chemical reactions and experiments that students run and can observe results from while seated at their desks. Microscale chemical reactions have been developed for this purpose, but with limited utility, primarily because in the classroom the choice of the types of reactions which can be carried out in open systems will be highly restricted for safety reasons.

Conduction of chemical reactions by students can be a valuable aspect of learning chemistry. Thus, students may conduct chemical reactions in the classroom or in a laboratory. However, in both situations students conducting such reactions are potentially liable to chemical exposure caused by handling, spills or breakage of containers because such reactions are generally conducted in open glass containers. In addition, teachers are typically required to have access to a laboratory area, to maintain required chemical storage areas in accordance with a chemical hygiene plan, to prepare necessary solutions for conducting experiments or for demonstrating reactions, to enforce standard safety practices during the conduction of experiments and to dispose of waste chemicals in a proscribed manner. Therefore, it would be an advance in the educational process if safer, simpler methods were developed to allow students to directly carry out and observe chemical reactions in a classroom setting.

Inventor, J. A. Forestiere, in U.S. Pat. No. 3,036,894, that issued May 29, 1962 discloses a method whereby chemical reactions between a substance to be tested and one or more testing reagents can be progressively accomplished within a closed system, provided by the testing container, to a desired end point, so that a given testing procedure can be easily and quickly carried out without technical training.

In addition, Gleason, et al, in U.S. Pat. No. 6,300,138, that issued on Oct. 9, 2001 deals with methods and apparatii for automated sample analysis that has a plurality of actuators and moves samples from one compartment to another.

U.S. Pat. No. 3,348,921 discloses a safer, large scale system for demonstrating chemical reactions comprising reservoirs, conduits and flasks molded into a rigid transparent body. However, the system of the '921 patent requires filling reservoirs with liquid reactants and use as an open container.

### SUMMARY OF THE INVENTION

What is disclosed and claimed herein is a method of incorporating an active learning experience into a classroom, the method comprising (A) providing a teaching kit to at least one student and (B) allowing the student to make predictions about expected results from information on the kit and (C) allowing the student to interact with the teaching kit to perform one or more reactions.

Thereafter, (D) allowing the student to report the results of the interactivity and (E) allowing a teacher to interact with the student regarding the student's results.

In addition, the method can incorporate additional steps such as (A₁), allowing the student to become familiar with any instructions associated with the kit. Further, another step would be (B₁), allowing the student to interact with the teacher between steps (B) and (D). Finally, there is a step that optionally includes a safe and environmentally effective discard of the kit.

This invention includes another embodiment, that is, a teaching kit for use in the method, said teaching kit comprising (I) an article of manufacture, comprising a package fabricated of upper and lower transparent sheet material defining at least a first closed chamber containing a first fluid reactant and an adjacent second closed chamber containing a reactive component, the package formed by sealing the upper sheet material to the lower sheet material at the periphery of the chambers, at least the upper sheet material being flexible so that when the first chamber is pressed, then the first fluid reactant will break the seal between the first and second chambers and flow into the second chamber to react with the reactive component(s)in the second chamber to produce an observable reaction product, such as a precipitate or color change or a physical change such as a cooling or heating process.

Further, the kit contains (II), written instructions for the use of the article of manufacture. As an optional component, the kit can contain (III), a series of written predetermined questions for the user of the kit. It is contemplated within the scope of this invention to optionally include in the kit, a written technical discussion to aid the interpretation of any results obtained by the user of the kit. Further contemplated with the scope of this invention is to optionally include a sealed package in the kit to be opened upon completion of the use of the kit, said sealed package providing answers for the questions provided in step (III). Finally, it is contemplated within the scope of this invention to include in the kit a printed form for reporting the user results to a teacher.

### BRIEF DESCRIPTION OF THE DRAWINGS

FIG. 1 shows a side cross-sectional view of a package used in the instant invention fabricated of upper and lower flexible sheet material defining a first closed chamber containing a first fluid reactant and an adjacent second closed chamber containing a reactive component, the package formed by sealing the upper flexible sheet material to the lower flexible sheet material at the periphery of the chambers. The volumes of the chambers would be 0.5 mL or less.

FIG. 2 shows a top view of the package of FIG. 1.

FIG. 3 shows a top view of a package used in the instant invention having five peripheral reagent chambers and a central reaction chamber useful, for example, in demonstrating titrations.

FIG. 4 shows a top view of a package used in the instant invention having three successive chambers useful, for example, in demonstrating a two-step reaction.

FIG. 5 shows a top view of a package used in the instant invention having three reagent chambers adjacent an elongated reaction chamber useful, for example, for the observation of a diffusion process.

FIG. 6 shows a top view of a package used in the instant invention having instructions printed thereon.

FIG. 7 shows a side view of a process for filling vacuum formed depressions in a flexible sheet material with a fluid reactant and a fluid reactive component.

FIG. 8 shows a side view of a process for sealing the flexible sheet material of FIG. 7 to a relatively rigid sheet material to produce a package to be provided in the instant invention.

FIG. 9 shows the package of FIG. 8 being used by a student to carry out a chemical reaction.

FIG. 10 shows a process for making packages to be used in the instant invention from tube sections.

### DETAILED DESCRIPTION OF THE INVENTION

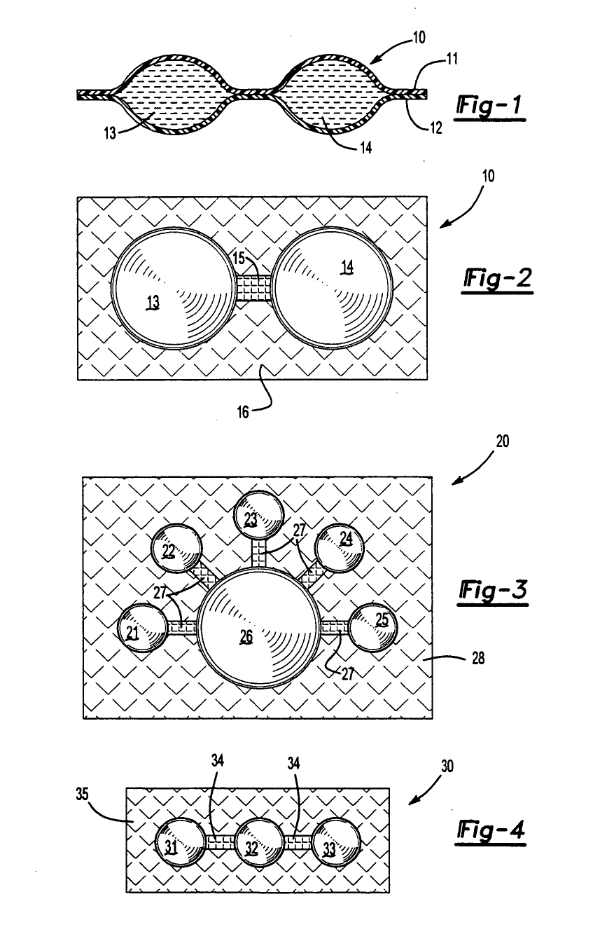

Referring now to FIG. 1, therein is shown a side cross-sectional view of a package 10 to be provided in the instant invention comprised of an upper layer 11 and lower layer 12 of flexible transparent Surlyn® brand thermoplastic sheet material from DuPont (E. I. du Pont de Nemours and Company, Wilmington, Del.). The upper layer 11 and the lower layer 12 define a first closed chamber 13 containing a dilute solution of sodium chloride. The upper layer 11 and the lower layer 12 also define a second closed chamber 14 containing a dilute solution of silver nitrate.

Referring now also to FIG. 2, therein is shown a top view of the package 10 of FIG. 1. The chambers 13 and 14 are formed by sealing the upper layer 11 to the lower layer 12 at the periphery of the chambers. However, the strength of the seal between the layers 11 and 12 between the chambers 13 and 14 is weaker than the strength of the seal between the layers 11 and 12 of the remaining portion of the package 10. Referring specifically to FIG. 2, the relatively weaker seal between the chamber 13 and 14 is indicated by the smaller cross-hatching 15 while the relatively stronger remaining seal is indicated by the larger cross-hatching 16. When the first chamber 13 is pressed (for example, by pressing the chamber 13 by pressure between the fingers of a student) then the dilute sodium chloride in the chamber 13 breaks the seal between the chamber 13 and the chamber 14 and flows into the chamber 14 to react with the dilute silver nitrate in the chamber 14 to form silver chloride which is apparent to the student through the package 10 as a white precipitate.

The package 10 is preferably formed and filled with the reagents using the apparatus and method described in U.S. Pat. No. 6,342,123 B1 issued Jan. 29, 2002 to Rees et al. The '123 patent teaches how to form a relatively weak seal (a “differentially frangible seal” in the language of the '123 patent) between chambers filled with different liquids or other materials. However, it should be understood that although it is preferable to form a “differentially frangible seal” between the chambers, the seal strength around the periphery of the chambers can be the same between the chambers as elsewhere: (a) if the distance between the edges of the chambers is small relative to the distance between the edges of the chambers and the nearest edge of the package (or the edge of another chamber with which flow is not desired); and (b) if the seal strength is sufficiently weak to allow seal breakage between the chambers when the chamber is pressed. Preferably, the chambers to be pressed are about the size of a thumbprint, i.e., about one centimeter in diameter, so that essentially complete transfer of the fluid from the chamber occurs when the chamber is pressed.

The preferred material for the upper and lower flexible sheets of the instant invention is Surlyn brand polymer from DuPont because of its toughness, its clarity, its chemical resistance and its ability to form the preferred “differentially frangible seal” between the chambers. However, it should be understood that many different materials can be used in the flexible sheet material of instant invention such as thermoplastic urethane resins (available, for example, from The Dow Chemical Company, Midland Mich.) as well as more common thermoplastic polymers such a polyethylene, polypropylene and polyester. In addition, at least one of the flexible sheets must be sufficiently clear (or at least translucent) to observe the reaction product(s) through such sheet. It should also be understood that the flexible sheet material used in the instant invention can be multi-layered so that, for example, one layer has desirable barrier properties while another layer has desirable sealing properties.

Referring now to FIG. 3, therein is shown a top view of a package 20 to be provided in the instant invention having five peripheral reagent chambers and a central reaction chamber 26. As in the package shown in FIG. 2, the seal strength between the flexible sheets in the area indicated by the small cross-hatching 27 is relatively weaker than the seal strength in the area indicated by the larger cross-hatching 28. The central reaction chamber 26 is partially filled with a dilute solution of acetic acid and phenolphthalein acid-base indicator. The chambers 21, 22, 23, 24 and 25 are each filled with a dilute solution of sodium hydroxide. The concentration and volume of sodium hydroxide in the chambers 21, 22, 23, 24 and 25 is matched to the concentration and volume of acetic acid in the chamber 26 so that as each chamber 21, 22, 23, 24 and 25 is successively pressed to force its contents into the chamber 26, the acetic acid in the chamber 26 is titrated by the sodium hydroxide in the chambers 21-25 and the endpoint indicated by the color change observed in the chamber 26.

Referring now to FIG. 4, therein is shown a top view of a package 30 to be provided in the instant invention having a chamber 31, a chamber 32 and a chamber 33. As in the package shown in FIG. 2, the seal strength between the flexible sheets in the area indicated by the small cross-hatching 34 is relatively weaker than the seal strength in the area indicated by the larger cross-hatching 35. The chamber 31 is filled with a dilute solution of sodium chloride. The chamber 32 is filled with a dilute solution of silver nitrate. The chamber 33 is filled with a dilute solution of sodium thiosulfate. When chamber 31 is pressed, the dilute solution of sodium chloride is forced into chamber 32 and reacts with the silver nitrate in the chamber 32 to form silver chloride. The silver chloride is apparent to the student as a white precipitate. Then the student presses chamber 33 to force the dilute solution of sodium thiosulfate into the chamber 32. The sodium thiosulfate reacts with the silver chloride precipitate to dissolve the precipitate and cause its disappearance.

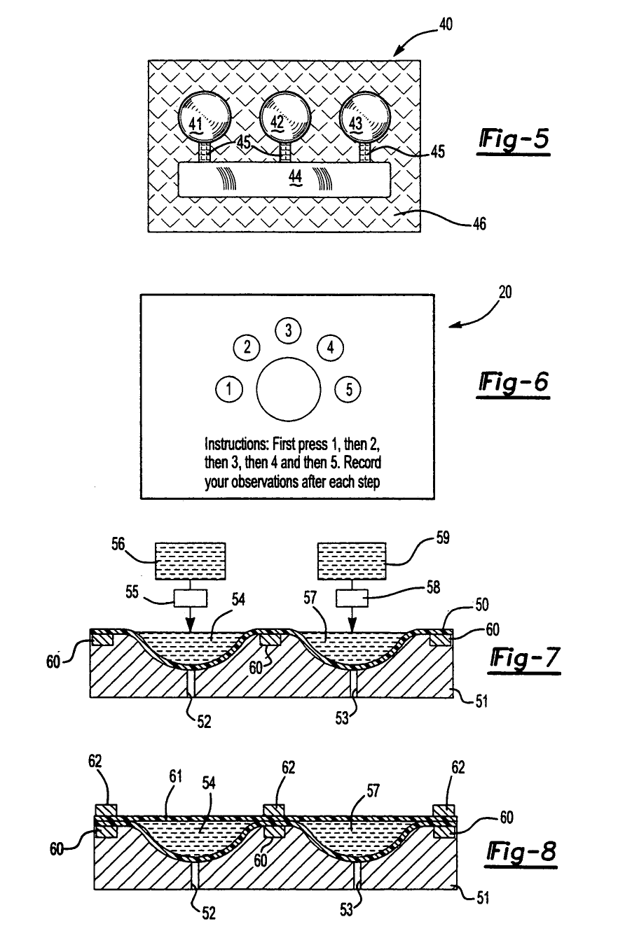

Referring now to FIG. 5, therein is shown a top view of a package 40 to be provided in the instant invention having three reagent chambers 41, 42 and 43 adjacent an elongated reaction chamber 44. As in the package shown in FIG. 2, the seal strength between the flexible sheets in the area indicated by the small cross-hatching 45 is relatively weaker than the seal strength in the area indicated by the larger cross-hatching 46. The chamber 44 can be filled with a reagent or can be empty as desired and the number of reagent chambers can be essentially any number as desired.

Referring now to FIG. 6, therein is shown a top view of the package 20 of FIG. 3. However, in FIG. 6 instructions to the student are shown printed on or between the layers of the package.

Referring now to FIGS. 7 and 8, therein is shown an alternative method for producing a package to be provided in the instant invention. A flexible sheet 50 of Surlyn brand thermoplastic resin has been laid on an aluminum vacuum forming die 51 with vacuum applied to ports 52 and 53 so that the flexible sheet 50 is formed into two one centimeter diameter depressions in the die 51. The first depression is filled with a dilute solution of hydrochloric acid and phenolphthalein 54 by way of automatic measuring and dispensing system 55 from reservoir 56. The second depression is filled with a dilute solution of sodium bicarbonate 57 by way of automatic measuring and dispensing system 58 from reservoir 59. Then a sheet 61 of relatively rigid polypropylene (pigmented with white titanium dioxide pigment to provide a favorable color observation backdrop) is positioned on the filled sheet 50 and heat-sealed thereto by heat-sealers 60 and 62 so that “differentially frangible” seals are formed between the chambers containing the fluid reactant 54 and the fluid reactive component 57.

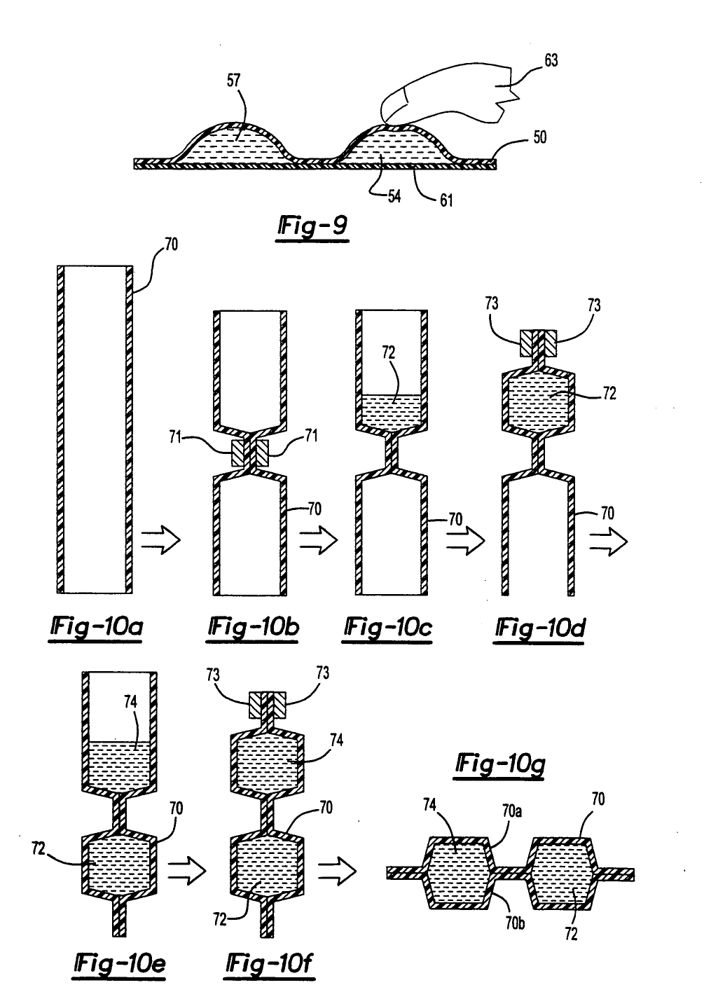

Referring now to FIG. 9 therein is shown the package made by the process discussed above in reference to FIGS. 7 and 8 as provided to a student. FIG. 9 shows the student's finger 63 pressing on the first chamber containing the fluid reactant 54. The package shown in FIG. 9 comprises a flexible sheet 50 and a relatively rigid sheet 61. It should be understood that when a package provided in the instant invention comprises a flexible sheet and a relatively rigid sheet, the flexible sheet is the “upper sheet” as defined in the following claims.

Referring now to FIG. 10 therein is shown another alternative method for producing a package to be provided in the instant invention. A flexible tube 20 of Surlyn brand thermoplastic resin, as shown in FIG. 10(a), is pinched in its middle portion by heat sealers 71 to seal the sides of the tube together at the middle of the tube 70 as shown in FIG. 10(b) to form a cup shaped section of the tube 70 above and below the middle seal. A first fluid reactant 72 is introduced into the upper cup shaped section of the tube 70 as shown in FIG. 10(c) and then the upper cup shaped section if the tube 70 is heat sealed by heat sealers 73 so that the first fluid reactant 72 is now contained in a closed chamber at the upper end of the tube 70. The tube 70 is then inverted and a reactive component 74 (in liquid form) is introduced into the remaining cup shaped section of the tube 70 as shown in FIG. 10(e) and then heat sealed by heat sealers 73 as shown in FIG. 10(f). The seal made by the heat sealers 71 is a “differentially frangible seal” relative to the seal made by the heat sealers 73. Referring now to FIG. 10(g), it will be understood that even though the tube 70 is a continuous sheet of material, for the purposes of this invention and the following claims, the tube 70 is comprised by an upper sheet 70a and a lower sheet 70b. Although FIG. 10(g) shows a two-chambered package to be provided in the instant invention, it will readily be appreciated that packages for the instant invention having more than two chambers can be made from tube sections.

Of course the instant invention is not limited to the specific examples detailed above. Other examples include other acid-base and other precipitation/solution reactions, heterogeneous reactions, such as the reaction of copper with silver nitrate to form silver metal and copper nitrate, endothermic or exothermic reactions, such as the reaction of ammonium chloride powder with water, dissolution reactions, such as the dissolution of foamed polystyrene in acetone, photochemical reactions, such as the darkening of silver chloride precipitate in sunlight, gas forming reactions, such as the reaction of acetic acid with sodium bicarbonate to form carbon dioxide, oxidation-reduction reactions, such as a sequential titration of potassium permanganate with sodium thiosulfate to form a series of colored oxidized manganese species, hydrolysis reactions, polymerization reactions and, without limitation, fermentation reactions.

Referring now to FIGS. 1-10, the package provided in the instant invention must define at least two chambers, as shown, for example, in FIG. 2, but may contain more than two chambers, as shown, for example, in FIGS. 3-5. It should be understood that the first chamber that is pressed is the “first closed chamber” required by the following claims even if such chamber is described in other terms in the above discussion. For example: (a) if the chamber 14 is pressed first in the embodiment shown in FIG. 1, then chamber 14 is the “first closed chamber” required by the following claims, but (b) if the chamber 13 is pressed first in the embodiment shown in FIG. 1, then chamber 13 is the “first closed chamber” required by the following claims.

Turning now to the method of incorporating an active learning experience into a classroom, the method provides a kit to at least one student, and the teacher and the student utilize the kit together in order for the student to learn. Sometimes, the student can receive the kit and be left to his or her own interpretation of the use of the kit and the information that is to be derived from the kit. In other circumstances, the teacher can be readily involved and provide a much more interesting event and one that is certain to enhance the student's level of learning.

Thus, the method provides, in the alternative, for the intervention of the teacher at specific points in time relative to the use of the kit.

The description above relates primarily to a number of specific embodiments. However, the disclosure of such specific embodiments is not intended as a limitation of the scope of the instant invention. Thus, it is readily apparent that although the invention has been described in relation to its preferred embodiments and several alternative embodiments, it should be understood that the scope of the instant invention is not limited thereby but is intended to cover all alternatives, modifications and equivalents that are included within the scope of the invention as defined by the following claims.

What is claimed is:

1. A method of incorporating an active learning experience into a classroom, the method comprising:
(A) providing a teaching kit to at least one student;
(B) allowing the student to make predictions as to the outcome of a reaction from information provided by the kit:
(C) allowing the student to interact with the teaching kit;
(D) allowing the student to report the results of the interactivity;
(E) allowing a teacher to interact with the student regarding the student's results.

2. The method as claimed in claim 1 wherein there is an intermediate step between steps (A) and B) that is (A₁), allowing the student to become familiar with any instructions associated with the kit.

3. The method as claimed in claim 1 wherein there is an intermediate step between steps (B) and (D) that is (B₁), allowing the student to interact with the teacher.

4. The method as claimed in claim 1 wherein there is an additional step (F), discarding the teaching kit in an effective environmental method.

5. A teaching kit, said teaching kit comprising
(I) an article of manufacture, comprising a package fabricated of upper and lower sheet material defining at least a first closed chamber containing a first fluid reactant and an adjacent second closed chamber containing a reactive component, the package formed by sealing the upper sheet material to the lower sheet material at the periphery of the chambers, at least the upper sheet material being flexible so that when the first chamber is pressed, then the first fluid reactant will break the seal between the first and second chambers and flow into the second chamber to react with the reactive component in the second chamber to produce a reaction product;
(II) written instructions for the use of the article of manufacture;
(III) a series of written predetermined questions for the user of the kit.

6. The teaching kit as claimed in claim 5 wherein there is an additional component (IV), a written technical discussion to aid the interpretation of any results obtained by the user of the kit.

7. The teaching kit as claimed in claim 5 wherein there is a sealed package contained in the kit that is to be opened upon completion of the use of the kit, said sealed package providing answers for the questions provided in step (III).

8. The teaching kit as claimed in claim 5 wherein there is a printed form for reporting the user results to a teacher.

9. The teaching kit as claimed in claim 5 wherein the kit contains an article of manufacture that contains the reagents to provide a reaction product that is the result of enzyme catalysis.

10. The teaching kit as claimed in claim 5 wherein the kit contains an article of manufacture that contains the reagents to provide a reaction product that is hotter or colder that either reactant immediately prior to the reaction.

11. The teaching kit as claimed in claim 5 wherein the kit contains an article of manufacture that contains the reagents to provide a reaction product that is formed slowly enough that its kinetics of appearance can be determined.

12. The teaching kit as claimed in claim 5 wherein the kit contains an article of manufacture that contains the reagents to provide a reaction product that is a gas.

13. The teaching kit as claimed in claim 5 wherein the kit contains an article of manufacture that contains the reagents to provide a reaction product that is a precipitate.

14. The teaching kit as claimed in claim 5 wherein the kit contains an article of manufacture that contains the reagents to provide a reaction product that changes color.
